(19) United States
(12) Patent Application Publication
(10) Pub. No.: US 2025/0348980 A1
(43) Pub. Date: Nov. 13, 2025

(54) PROCESSING MULTI-MODAL INPUTS USING DENOISING NEURAL NETWORKS

(71) Applicant: GDM Holding LLC, Mountain view, CA (US)

(72) Inventors: Cheuk Kit Kelvin Chan, Redmond, WA (US); Hexiang Hu, Redmond, WA (US); Wenhu Chen, Waterloo (CA); Yu-Chuan Su, Bellevue, WA (US)

(21) Appl. No.: 19/207,249

(22) Filed: May 13, 2025

Related U.S. Application Data
(60) Provisional application No. 63/646,609, filed on May 13, 2024.

(51) Int. Cl. G06T 5/60; G06T 5/70

(52) U.S. Cl. CPC G06T 5/60; G06T 5/70

(57) ABSTRACT

Methods, systems, and apparatus, including computer programs encoded on computer storage media, for processing multi-modal inputs using denoising neural networks.

### CROSS-REFERENCE TO RELATED APPLICATION

This application claims priority to U.S. Provisional Application No. 63/646,609, filed on Mar. 13, 2024. The disclosure of the prior application is considered part of and is incorporated by reference in the disclosure of this application.

### BACKGROUND

This specification relates processing images using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers in one or more locations that generates a target data item, e.g., an image, using a latent denoising neural network and conditioned on a multi-modal input.

In implementations the latent denoising neural network is a diffusion model neural network that is used to perform a reverse diffusion process which generates the target data item by iteratively denoising a representation of the target data item in a latent space that is a reduced-dimensional (compressed) representation of the target data item.

In one aspect, a method includes receiving a multi-modal input, wherein the multi-modal input comprises: a text instruction that describes an image generation task to be performed with reference to a set of one or more reference images, wherein the text instruction includes a respective text reference to each of the one or more reference images, and a respective text-image pair for each reference image in the set, wherein each text-image pair comprises (i) the reference image and (ii) the respective text reference for the reference image; initializing a latent representation of a target image for the image generation task in a latent space; processing the text instruction using a text encoder neural network to generate a text representation of the text instruction; for each text-image pair: processing the reference image in the pair using a latent encoder neural network to generate a reference latent representation of the reference image in the latent space, and processing the text reference in the pair using the text encoder neural network to generate a reference text representation of the text reference; and updating the latent representation of the target image using a latent denoising neural network, the updating comprising: for each text-image pair, processing the reference latent representation of the reference image in the pair and the reference text representation of the text reference in the pair using a denoising encoder neural network of the latent denoising neural network to generate an encoded representation of the text-image pair; and at each of a plurality of reverse diffusion steps: generating a denoising output in the latent space for the reverse diffusion step, comprising: processing a first diffusion input for the reverse diffusion step that comprises (i) the latent representation of the target image and (ii) the text representation of the text instruction using the denoising encoder neural network to generate a first encoded representation of the target image; and processing the first encoded representation of the target image and the encoded representations of the text-image pairs using a denoising decoder neural network of the latent denoising neural network to generate a first denoising output in the latent space; and updating the latent representation of the target image using the denoising output; and after updating the latent representation of the target image using the latent denoising neural network, processing the latent representation using a latent decoder neural network to generate the target image.

In some implementations, the set of one or more reference images comprises a plurality of reference images.

In some implementations, processing the first encoded representation of the target image and the encoded representations of the text-image pairs using a denoising decoder neural network of the latent denoising neural network to generate a first denoising output comprises: generating a decoder input sequence that includes (i) embeddings from the first encoded representation of the target image and (ii) for each text-image pair, embeddings from the encoded representation of the text-image pair; and processing the decoder input sequence using the denoising decoder neural network to generate the first denoising output.

In some implementations, the denoising decoder neural network comprises one or more self-attention layers that each update the embeddings in the decoder input sequence by applying self-attention over the embeddings in the decoder input sequence.

In some implementations, for each text-image pair, processing the reference latent representation of the reference image in the pair and the reference text representation of the text reference in the pair using a denoising encoder neural network of the latent denoising neural network to generate an encoded representation of the text-image pair comprises: generating an encoder input sequence that includes (i) embeddings from the reference latent representation of the reference image in the pair and (ii) embeddings from the reference text representation of the text reference in the pair; and processing the encoder input sequence using the denoising encoder neural network to generate the encoded representation of the text-image pair.

In some implementations, the denoising encoder neural network comprises one or more self-attention layers that each update the embeddings in the encoder input sequence by applying self-attention over the embeddings in the encoder input sequence.

In some implementations, processing a first diffusion input for the reverse diffusion step that comprises (i) the latent representation of the target image and (ii) the text representation of the text instruction using the denoising encoder neural network to generate a first encoded representation of the target image comprises: generating a new encoder input sequence that includes (i) embeddings from the latent representation of the target image and (ii) the text representation of the text instruction; and processing the new encoder input sequence using the denoising encoder neural network to generate the first encoded representation of the target image.

In some implementations, the latent denoising neural network has been pre-trained on one or more text-conditioned image generation tasks.

In some implementations, after the pre-training, the latent denoising neural network has been trained on a task that requires generating images conditioned on training multi-modal inputs that each include (i) a respective training text instruction that describes an image generation task to be performed with reference to a respective set of one or more training reference images and (ii) the respective set of one or more training reference images.

In some implementations, the latent encoder and latent decoder neural networks have been held fixed during the training of the latent denoising neural network on the task that requires generating images conditioned on the training multi-modal inputs.

In some implementations, the latent encoder and latent decoder neural networks have been pre-trained on an image reconstruction task prior to the pre-training of the latent denoising neural network on the one or more text-conditioned image generation tasks.

In some implementations, the text encoder neural network has been held fixed during the training of the latent denoising neural network on the task that requires generating images conditioned on the training multi-modal inputs.

In some implementations, the denoising output in the latent space for the reverse diffusion step is the first denoising output.

In some implementations, generating a denoising output in the latent space for the reverse diffusion step further comprises: processing a second, unconditional diffusion input for the reverse diffusion step that comprises the latent representation of the target image using the denoising encoder neural network to generate a second encoded representation of the target image; processing the second encoded representation of the target image using the denoising decoder neural network to generate a second denoising output in the latent space; and combining the first and second denoising outputs in accordance with a guidance weight for the reverse diffusion step to generate the denoising output.

In another aspect, a method comprises receiving a multi-modal input, wherein the multi-modal input comprises: a text instruction that describes a data item generation task to be performed with reference to a set of one or more reference data items, wherein the text instruction includes a respective text reference to each of the one or more reference data items, and wherein each of the reference data items are of a respective different modality that is not text; and a respective text-data item pair for each reference data item in the set, wherein each text-data item pair comprises (i) the reference data item and (ii) the respective text reference for the reference data item; initializing a latent representation of a target data item for the data item generation task in a latent space; processing the text instruction using a text encoder neural network to generate a text representation of the text instruction; for each text-data item pair: processing the reference data item in the pair using a latent encoder neural network to generate a reference latent representation of the reference data item in the latent space, and processing the text reference in the pair using the text encoder neural network to generate a reference text representation of the text reference; updating the latent representation of the target data item using a latent denoising neural network conditioned on, for each text-data item pair, the reference latent representation of the reference data item in the pair and the reference text representation of the text reference in the pair; and after updating the latent representation of the target data item using the latent denoising neural network, processing the latent representation using a latent decoder neural network to generate the target data item.

In some implementations, updating the latent representation of the target data item using a latent denoising neural network comprises: for each text-data item pair, processing the reference latent representation of the reference data item in the pair and the reference text representation of the text reference in the pair using a denoising encoder neural network of the latent denoising neural network to generate an encoded representation of the text-data item pair; and at each of a plurality of reverse diffusion steps: generating a denoising output in the latent space for the reverse diffusion step, comprising: processing a first diffusion input for the reverse diffusion step that comprises (i) the latent representation of the target data item and (ii) the text representation of the text instruction using the denoising encoder neural network to generate a first encoded representation of the target data item; and processing the first encoded representation of the target data item and the encoded representations of the text-data item pairs using a denoising decoder neural network of the latent denoising neural network to generate a first denoising output in the latent space; and updating the latent representation of the target data item using the denoising output.

In some implementations, the target data item is an image.

In some implementations, the target data item is audio data representing an audio signal.

In some implementations, the target data item is a video comprising a plurality of video frames.

In some implementations, the reference data items are images.

In some implementations, the reference data items are audio data representing audio signals.

In some implementations, the reference data items are video each comprising a plurality of video frames.

In some implementations, the reference data items are a same modality as the target data item.

In some implementations, the reference data items are a different modality from the target data item.

In some implementations, the set of one or more reference data items comprises a plurality of reference data items.

In another aspect, a system comprising one or more computers and one or more storage devices stores instructions that are operable, when executed by the one or more computers, to cause the one or more computers to perform the operations of the respective method of any implementation of any preceding aspect.

In another aspect, a computer storage medium encoded with instructions that, when executed by one or more computers, cause the one or more computers to perform the operations of the respective method of any implementation of any preceding aspect.

Particular embodiments of the subject matter described in this specification can be implemented so as to realize one or more of the following advantages.

This specification describes techniques for effectively using a latent denoising neural network to follow a multi-modal instruction when generating a target data item, e.g., an image. That is, the described techniques leverage a latent denoising neural network to generate a target data item that accurately follows a multi-modal instruction that includes a text instruction that indicates how content from a set of one or more reference data items, e.g., reference images, should be incorporated into the target data item. That is, the multi-modal instruction includes both a text instruction and one or more reference data items, e.g., images, that are referenced by the text instruction. The multi-modal instruction can also include respective reference text for each reference data item. The reference text can provide context for how the corresponding reference data item is described by the text instruction.

Denoising neural networks, e.g., latent denoising neural networks, when trained as part of a diffusion model framework, have been shown to be capable of generating high-quality images that are consistent with an input text prompt. That is, denoising neural networks have been shown to be able to accurately perform text-to-image tasks.

However, using these neural networks to generate images that follow multi-modal instructions, e.g., inputs that include both a set of reference images and text that describes how the generated image should relate to the set of reference images, remains a challenge.

For example, some existing approaches struggle with generating target images that maintain consistency with the reference images.

As another example, some existing approaches struggle to modify the object(s) or, more generally, the scene as depicted in the reference images, i.e., struggle to adhere to the text instruction without merely copying the scene depicted in the reference images.

As yet another example, some existing approaches require a neural network architecture that is significantly more compute and memory intensive relative to the architecture of a denoising neural network that can accurately perform text-to-image tasks. As a result, these approaches consume a large number of computing resources during training and have prohibitive deployment requirements (in terms of compute and memory) that do not allow them to be used in inference environments where low latency generation is required.

This specification describes techniques that address these issues and allow the latent denoising neural network to follow a multi-modal instruction when generating a target data item, e.g., an image.

In particular, the system generates a separate encoded representation of each reference text-reference data item pair that serve as references for the target data item generation and conditions each reverse diffusion step on these encoded representations while also conditioning the reverse diffusion step on a text representation of the text instruction. This allows the latent denoising neural network to effectively incorporate context from the reference data items when updating the latent representation at each reverse diffusion step, resulting in an output target data item that faithfully follows the multi-modal instruction.

Moreover, the system performs the reverse diffusion steps in a latent space that is lower-dimensional than the output space of the target data item, increasing the computational efficiency of the data item generation process. More specifically, the system generates the encoded representations from representations of the reference data items in the latent space. Thus, the system does not need to store the original, higher-dimensional reference data items while performing the reverse diffusion steps, reducing the amount of memory required to perform the data item generation process.

In some cases, the system configures the latent denoising neural network to have the same number of parameters as a pre-trained text-to-image denoising neural network neural network, despite the text-to-image neural network only being able to process text inputs. In other words, by configuring the latent denoising neural network to have the architecture described in this specification, the system can adapt the pre-trained text-to-image denoising neural network to be able to perform the more complex multi-modal instruction following task without increasing the memory and compute requirements for training or performing inference using the neural network. More specifically, during inference, the denoising neural network processes the text-data item pairs using components that are “re-purposed” components, e.g., a latent encoder neural network, a text encoder neural network, and a denoising encoder of the latent denoising neural network, that were already present as part of the text-to-image denoising neural network, rather than new components that needed to be added to the architecture of the neural network to accommodate the new type of conditioning input. Additionally, this allows the latent denoising neural network to be fine-tuned starting from the pre-trained text-to-image denoising neural network, significantly increasing the computational efficiency and decreasing the amount of memory and processor cycles relative to training the latent denoising neural network from scratch to process multi-modal inputs.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example multi-modal processing system.

FIG. 2 is a flow diagram of an example process for generating a target image.

FIG. 3 is a flow diagram of an example process for updating the latent representation of the target image.

FIG. 4 shows an example of the operation of the multi-modal processing system.

FIG. 5 is a flow diagram of an example process for generating a target data item.

Like reference numbers and designations in the various drawings indicate like elements.

### DETAILED DESCRIPTION

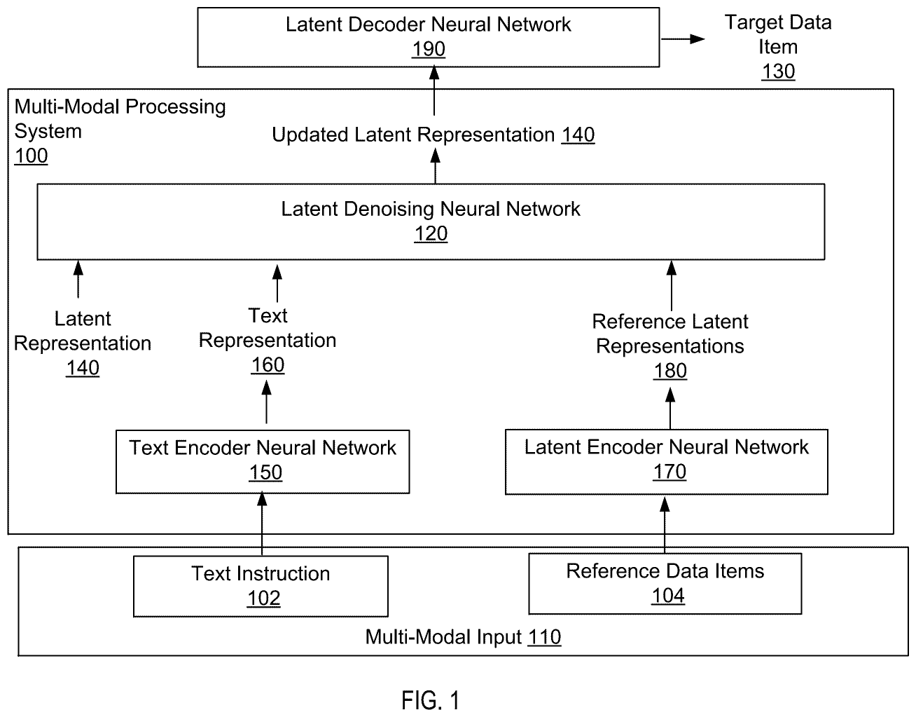

FIG. 1 is a diagram of an example multi-modal processing system 100. The multi-modal processing system 100 is an example of a system implemented as computer programs on one or more computers in one or more locations, in which the systems, components, and techniques described below can be implemented.

The system 100 generates a target data item 130, e.g., a target image, using a latent denoising neural network 120 and conditioned on a multi-modal input 110.

The multi-modal input 110 includes a text instruction 102 that describes a data item generation task to be performed with reference to a set of one or more reference data items 104.

That is, the text instruction 102 describes how the task should be performed by referring to a set of one or more reference data items 104 and therefore includes a respective text reference to each of the one or more reference data items 104.

Generally, the reference data items 104 are data items that provide information about the content of the target data item 130 that is to be generated by performing the data item generation task.

For example, when the task is to generate an image or a video of an object, the reference data items 104 can include one or more other images or videos of the object, one or more other images that depict a target shape or geometry of the object (e.g., mask images showing a masked region that should be occupied by the object or edge images showing the surface or edge of the object), and so on.

In some implementations, the text instruction 102 includes a respective reference to each of the one or more objects that are characterized by the reference data items 104. The objects can be objects in an image or video, or audio objects.

As another example, the reference data items 104 can include one or more images that represent a desired style for the target data item 130.

More generally, each reference data item 104 can correspond to a respective object or entity, and the text instruction 102 is said to include a respective text reference to each of the one or more reference data items 104 because the text instruction 102 includes a respective text reference to the respective object or entity corresponding to each of the reference data items 104.

The multi-modal input 110 also includes a respective text-data item pair for each reference data item in the set. Each text-data item pair includes (i) the reference data item and (ii) the respective text reference for the reference data item in the pair. As will be described below, the text in the text-data item pair can also include additional text (in addition to the text reference) that provides context for the text reference. That is, the input 110 not only includes the text that references the reference data items, but also includes the reference data items themselves. The respective text reference for the reference data item can be one of the references to an object in the text instruction 102.

The text reference for a reference data item generally describes or characterizes the reference data item.

As a particular example, the respective text reference for each reference data item in the text instruction 102 can include a respective identifier for the object or entity that corresponds to the reference data item 104, e.g., [ref #1] for object 1, [ref #2] for object 2, and so on, and the text reference for each reference data item can include the respective identifier for the corresponding object or entity. In this example, the respective reference can be in the form of text, e.g., a structured reference such as “[ref #1]” or a descriptor such as “dog”. That is, the respective identifier for an object or entity can be the respective reference to the object or entity in the text instruction 102.

The additional text in addition to the text reference for each reference data item can describe the relevance of the corresponding object or entity to the reference data item. One example piece of text that includes a text reference and additional text may be “an image of a [ref #1] dog looking aside,” which identifies the corresponding object as being a specific dog that is also referenced in the text instruction and indicates that the reference data item is an image of the specific dog looking in a particular direction.

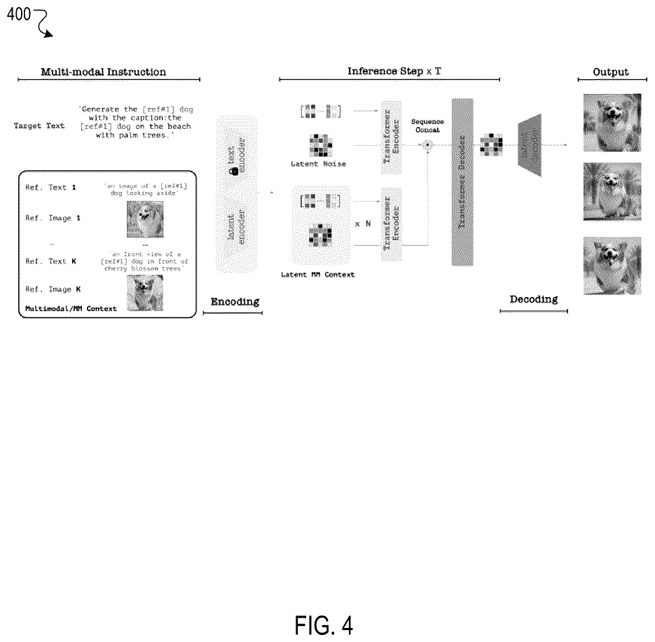

FIG. 4, described later, shows an example of a text instruction 102 that includes a respective text reference to each of a set of reference data items, in conjunction with example reference data items and the respective text references for the reference data items.

Generally, the input 110 is multi-modal because each of the reference data items are of a respective different modality that is not text, e.g., images, audio, or video.

As a particular example, the reference data items 104 and the target data item 130 can both be images (they can be, but need not be, of the same modality).

Other examples include examples where the reference data items, the target item or both are audio data representing an audio signal (i.e., a waveform, e.g., an audio waveform or a spectrogram representing the audio waveform), a video that includes multiple video frames, other data items that can be generated by one or more sensors, and so on.

As part of performing the data item generation task, the system 100 initializes a latent representation 140 of a target data item 130 for the data item generation task in a latent space.

The latent space is generally lower dimensional relative to the space of the target data item and, therefore, the latent representation 140 has a lower (spatial) dimensionality than the target data item 130 will when generated. For example, the system 100 can initialize the latent representation 140 by sampling noise values for each element of the data item, e.g., for each intensity value of each pixel of the image or video frame or for each amplitude value for each time step in an audio signal, from a specified noise distribution, e.g., a Gaussian distribution.

The system 100 processes the text instruction 102 using a text encoder neural network 150 to generate a text representation 160 of the text instruction 102.

The text encoder neural network 150 can be any appropriate encoder neural network, e.g., an encoder-decoder or decoder-only Transformer, a recurrent neural network (RNN), an encoder neural network that includes both recurrent and self-attention layers, or another type of neural network. For example, the text encoder neural network 150 can be a text encoder neural network that has been pre-trained on a representation learning objective, e.g., a contrastive learning objective, a captioning objective, a masked token prediction objective, and so on.

Any given text representation 160 generally includes one or more embeddings representing the corresponding text.

An embedding is an ordered collection of numerical values, e.g., a vector of floating point values or other numerical values.

For each text-data item pair, the system 100 processes the reference data item 104 in the pair using a latent encoder neural network 170 to generate a reference latent representation 180 of the reference data item in the latent space. The latent encoder neural network 170 can have any appropriate architecture, e.g., can be a Transformer neural network, a vision Transformer (ViT) neural network, a convolutional neural network, e.g., a ResNet, a recurrent neural network, a state space model (SSM), and so on. That is, the latent encoder neural network 170 can have any architecture that is appropriate for mapping a data item of a corresponding type to an output that includes one or more embeddings.

As specific examples, when the data item is an image or a video, the latent encoder neural network 170 can be a ViT, a convolutional neural network, or a neural network that includes both attention layers and convolutional layers. As another specific example, when the data item is an audio signal, the latent encoder neural network 170 can be a recurrent neural network or a convolutional neural network. Other types of neural network architectures can also be used.

Generally, the latent encoder neural network 170 has been pre-trained in an auto-encoder framework with a latent decoder neural network 190. That is, the latent encoder neural network 170 and the latent decoder neural network 190 have been trained jointly on a data item reconstruction task, e.g., on an objective that measures how well the latent decoder neural network 190 reconstructs input data items from latent representations generated by the latent encoder neural network 170. Examples of such objectives include variational auto-encoding

(VAE) objectives, vector quantization VAE (VQ-VAE) objectives, VQ generative adversarial networks (VQ-GAN) objectives, and so on.

The reference latent representation and the latent representations each generally also include one or more embeddings. For example, a given latent representation can be a feature map, e.g., a two-dimensional feature map or a three-dimensional feature map, that includes a respective embedding for each of one or more positions in the feature map.

The system 100 also processes the text reference in the pair using a text encoder neural network, e.g., the text encoder neural network 150, to generate a reference text representation of the text reference (not shown in FIG. 1).

The system then updates the latent representation 140 of the target data item 130 using the latent denoising neural network 120 conditioned on, for each text-data item pair, the reference latent representation 180 of the reference data item in the pair and the reference text representation of the text reference in the pair.

Generally, the system 100 uses the latent denoising neural network 120 to perform a reverse diffusion process in the latent space.

That is, the system 100 updates, using the latent denoising neural network 120, the latent representation 140 at each of multiple reverse diffusion steps.

Because the latent space is lower dimensional than the space of the target data item, the system 100 can perform this reverse diffusion process in a more computationally efficient manner than if the system 100 directly performed the reverse diffusion process in the space of the target data item 130 (by updating the target data item at each reverse diffusion step).

The latent denoising neural network 120 can have any architecture that maps an input, i.e., the latent representation 140, to an output of the same dimension, i.e., an updated, denoised version of the latent representation 140. As some examples the latent denoising neural network 120 can have a U-Net architecture or a variant thereof, or a Transformer neural network architecture (characterized by having a succession of attention layers) or a variant thereof, or a combination of these (e.g., a U-ViT architecture, Bao, et al., arXiv: 2209.12152, 2023). In general the latent denoising neural network 120 may comprise one or more feedforward, convolutional, attention, normalization, or other neural network layers.

The latent denoising neural network 120 can be conditioned on the text representation 160, the reference latent representation 180, and the reference text representation in any convenient way. For example one or more cross-attention layers can attend to the conditioning information, or the conditioning information can be provided as an extra input channel of, or otherwise concatenated with, the latent representation 140 at one or more layers of the latent denoising neural network 120, and so forth.

After updating the latent representation 140 of the target data item 130 using the latent denoising neural network 120, the system 100 processes the latent representation 140 using the latent decoder neural network 190 to generate the target data item 130.

As previously described, in general the text instruction describes a data item, e.g., image, generation task that is to be performed based on, the reference data items in the set. In general the task is to generate a new data item, e.g., image, using the reference data items, in particular using one or more objects represented in the reference data items and references by the respective text references. The text instruction can define how the object(s) should be incorporated in the target data item, e.g., image, that is generated.

In some implementations the reference data items can be obtained from real world data objects, e.g., from images captured by one or more cameras, sound captured by one or more microphones, and so forth. The target data item can represent a version of the reference data item(s) modified according to the text instruction, e.g., to change a representation, pose, background, perspective, or other aspect of the reference data item(s). Such an implementation may, e.g., be used in a mechanical control task to control a real-world mechanical agent such as a robot, e.g., using model predictive control.

The latent decoder neural network 190 can be any appropriate neural network that maps from the latent space to the space of the target data item 130. For example, the latent decoder neural network 190 can have a corresponding type of architecture to that of the latent encoder neural network 170.

An example of performing a reverse diffusion step when the latent denoising neural network 120 includes a (i) denoising encoder neural network followed by (ii) a denoising decoder neural network now follows.

In this example, prior to performing any reverse diffusion steps (or, equivalently, at the first reverse diffusion step), for each text-data item pair, the system 100 processes the reference latent representation of the reference data item in the pair and the reference text representation of the text reference in the pair using a denoising encoder neural network of the latent denoising neural network to generate an encoded representation of the text-data item pair.

Then at each of the reverse diffusion steps, the system generates a denoising output in the latent space for the reverse diffusion step.

Generally, any given denoising output, e.g., the denoising output, the first denoising output, or the second denoising output referenced below, defines an estimate of the noise component of the latent representation of the target data item, i.e., of the noise that has been added to a ground truth representation of the target data item to generate the latent representation.

For example, the denoising output can be a prediction of the noise component.

As another example, the denoising output can be an estimate of the ground truth representation.

As yet another example, the denoising output can be a prediction for a value that is a linear combination of: (i) the ground truth representation and (ii) the noise component, e.g., as implemented by the v-parametrization described in: Tim Salimans, Jonathan Ho, “Progressive distillation for fast sampling of diffusion models,” ICLR 2022, arXiv: 2202.00512v2

As part of generating the denoising output, the system 100 processes a first diffusion input for the reverse diffusion step that includes (i) the latent representation of the target data item and (ii) the text representation of the text instruction using the denoising encoder neural network to generate a first encoded representation of the target data item and processing the first encoded representation of the target data item and the encoded representations of the text-data item pairs using a denoising decoder neural network of the latent denoising neural network to generate a first denoising output in the latent space. Generally, any given diffusion input can also include one or more additional inputs, e.g., an input representing a time step corresponding to the reverse diffusion step, an input representing a noise level associated with the reverse diffusion step, and so on.

In some cases, the first denoising output is the denoising output. In some other cases, the system 100 uses classifier-free guidance. In these cases, the system also generates a second, unconditional denoising output and combines the first and second denoising outputs in accordance with a guidance weight for the reverse diffusion step.

The system 100 then updates the latent representation of the target data item using the denoising output.

For example, the system can determine an initial estimate of the ground truth representation using the denoising output and then apply an appropriate diffusion sampler, e.g., the DDPM (Denoising Diffusion Probabilistic Model) sampler (e.g., Ho, et al., arXiv: 2006:11239), the DDIM (Denoising Diffusion Implicit Model) sampler (e.g., Song, et al., “Denoising Diffusion Implicit Models,” arXiv: 2010.02502v4, October 2022) or another appropriate sampler, to the initial estimate to update the current representation. Optionally, at the last reverse diffusion step, the system 100 can use the initial estimate as the updated representation rather than using the diffusion sampler.

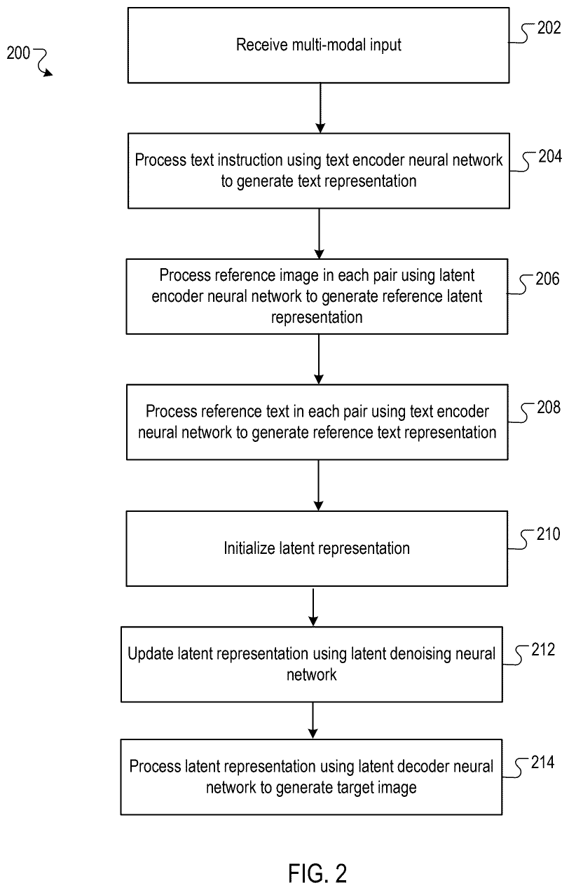

Performing the reverse diffusion steps will be described in more detail below with reference to FIGS. 2-4.

FIG. 2 is a flow diagram of an example process 200 for generating a target image. For convenience, the process 200 will be described as being performed by a system of one or more computers located in one or more locations. For example, a multi-modal processing system, e.g., the multi-modal processing system 100 depicted in FIG. 1, appropriately programmed in accordance with this specification, can perform the process 200.

The system receives a multi-modal input (step 202).

The multi-modal input includes a text instruction that describes an image generation task to be performed with reference to a set of one or more reference images. Generally, the text instruction includes a respective text reference to each of the one or more reference images. For example, each reference image can contain a depiction of a respective object or entity and the text instruction can include one or more references to each of the respective object or entity depicted in the one or more reference images.

The multi-modal input also includes a respective text-image pair for each reference image in the set, wherein each text-image pair includes (i) the reference image and (ii) the respective text reference for the reference image. The text in the pair can also include text that generally describes the given reference image, e.g., captions the scene depicted in the given reference image, in the context of the text reference.

The system processes the text instruction using a text encoder neural network to generate a text representation of the text instruction (step 204).

For each text-image pair, the system processes the reference image in the pair using a latent encoder neural network to generate a reference latent representation of the reference image in the latent space (step 206) and processes the text reference in the pair using the text encoder neural network to generate a reference text representation of the text reference (step 208). When the text in the pair also includes additional text, processing the text reference can refer to processing both the text reference and the additional text, so that the reference text representation of the text reference represents all of the text in the pair, i.e., both the text reference and the additional text. For example, when the text includes a text reference and additional text as follows: “an image of a [ref #1] dog looking aside,” the system can process the entire phrase “an image of a [ref #1] dog looking aside” using the text encoder neural network to generate the reference text representation.

Thus, after performing steps 204-208, the system transforms the multi-modal input into (i) a text representation of the text instruction and (ii) a respective latent representation and reference text representation for each text-image pair.

The system initializes a latent representation of a target image for the image generation task in the latent space (step 210).

The system updates the latent representation of the target image using a latent denoising neural network conditioned on the text representation of the text instruction and the representations for the text-image pairs (step 212).

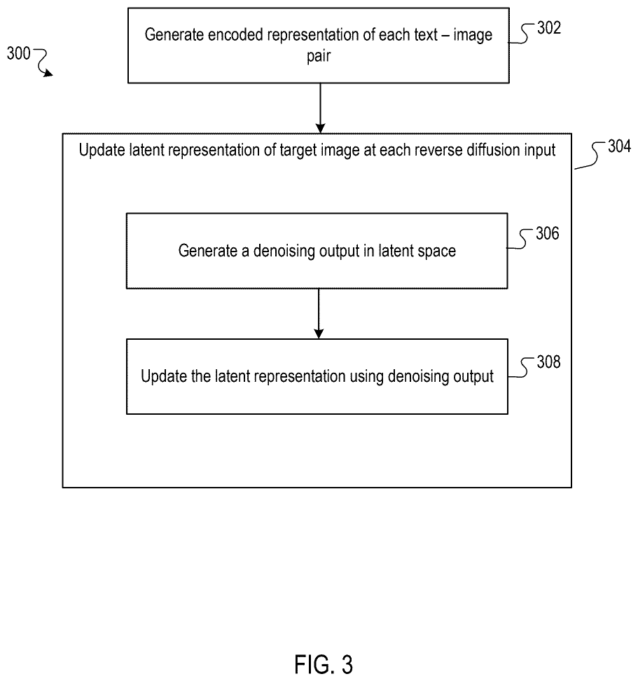

This updating will be described below with reference to FIG. 3.

After updating the latent representation of the target image using the latent denoising neural network, the system processes the latent representation using a latent decoder neural network to generate the target image (step 214).

FIG. 3 is a flow diagram of an example process 300 for updating the latent representation of the target image. For convenience, the process 300 will be described as being performed by a system of one or more computers located in one or more locations. For example, a multi-modal processing system, e.g., the multi-modal processing system 100 depicted in FIG. 1, appropriately programmed in accordance with this specification, can perform the process 300.

For each text-image pair, the system processes the reference latent representation of the reference image in the pair and the reference text representation of the text reference in the pair using a denoising encoder neural network of the latent denoising neural network to generate an encoded representation of the text-image pair (step 302).

The system then updates the latent representation at each of a plurality of reverse diffusion steps (step 304).

In particular, at each reverse diffusion step, the system performs steps 306 and 308 to update the latent representation as of the reverse diffusion step.

In more detail, the system generates a denoising output in the latent space for the reverse diffusion step (step 306).

As part of this, the system processes a first diffusion input for the reverse diffusion step that includes (i) the latent representation of the target image and (ii) the text representation of the text instruction using the denoising encoder neural network to generate a first encoded representation of the target image.

The system then processes the first encoded representation of the target image and the encoded representations of the text-image pairs using a denoising decoder neural network of the latent denoising neural network to generate a first denoising output in the latent space.

In some implementations, the first denoising output is the denoising output for the reverse diffusion step.

In some other implementations, the system generates one or more additional denoising outputs and then combines the multiple denoising outputs to generate the denoising output for the reverse diffusion step.

For example, the system can make use of classifier-free guidance.

In this example, the system also processes a second, unconditional diffusion input for the reverse diffusion step that includes the latent representation of the target image using the denoising encoder neural network to generate a second encoded representation of the target image. That is, the second, unconditional diffusion input includes the latent representation of the target image but does not include the representation of the text instruction.

The system processes the second encoded representation of the target image using the denoising decoder neural network to generate a second denoising output in the latent space, i.e., without also processing the encoded representations of the text-image pairs.

The system then combines the first and second denoising outputs in accordance with a guidance weight for the reverse diffusion step to generate the denoising output.

The system then updates the latent representation of the target image using the denoising output (step 308).

For example, the system can map the denoising output to an initial updated representation and then apply a diffusion sampler, e.g., the DDPM (Denoising Diffusion Probabilistic Model) sampler, the DDIM (Denoising Diffusion Implicit Model) sampler or another appropriate sampler, to the initial updated representation to generate an updated representation.

Optionally, after the last reverse diffusion iteration, the system can refrain from using the diffusion sampler and can instead use the initial updated representation as the updated representation.

FIG. 4 shows an example 400 of the operation of the multi-modal system 100.

As shown in the example 400, the system 100 receives a multi-modal instruction. The multi-modal instruction includes target text that specifies a text instruction for generating a target image.

In particular, the target text references an object ([ref #1] dog”) and specifies one or more desired properties of the object.

The multi-modal instruction also includes a set of text-image pairs, each text-image pair including an image of the referenced object and caption text that describes the referenced object and that includes the text reference ([ref #1] dog”). In the example 400, each reference image is an image of the referenced dog and the reference text describes how the referenced dog is depicted in the image. As can be seen from the example 400, each piece of text refers to the referenced dog using the same identifier (text reference) ([ref #1] dog) as the target text.

The system 100 processes the multi-modal instruction using a text encoder and a latent encoder to generate representations of the various inputs in the multi-modal instruction.

In particular, for each text-image pair, the system 100 processes the image and text in the pair to generate a reference latent representation of the reference image in the pair and a reference text representation of the text reference in the pair. The system 100 also processes the target text using the text encoder to generate a text representation of the instruction.

In the example 400, the latent denoising neural network includes a Transformer encoder and a Transformer decoder.

That is, in the example 400, the denoising encoder neural network is a neural network that includes one or more self-attention layers that each update the embeddings in an encoder input sequence provided as input to the denoising encoder neural network by applying self-attention over the embeddings in the encoder input sequence. For example, the denoising encoder neural network can include a stack of layer blocks that each include a respective self-attention layer.

Similarly, in the example 400, the denoising decoder neural network includes one or more self-attention layers that each update the embeddings in a decoder input sequence provided as input to the denoising decoder neural network by applying self-attention over the embeddings in the decoder input sequence. For example, the denoising decoder neural network can include a stack of layer blocks that each include a respective self-attention layer.

As described above, for each text-image pair, the system processes the reference latent representation of the reference image in the pair and the reference text representation of the text reference in the pair using the denoising encoder neural network of the latent denoising neural network to generate an encoded representation of the text-image pair. In the example 400, the system generates an encoder input sequence that includes (i) embeddings from the reference latent representation of the reference image in the pair and (ii) embeddings from the reference text representation of the text reference in the pair and processes the encoder input sequence using the denoising encoder neural network to generate the encoded representation of the text-image pair.

Thus, when there are N pairs, the system generates N encoded representations, one for each of the pairs.

The system also generates a latent representation of the target image, i.e., by sampling latent noise from an appropriate distribution.

The system then uses the encoded representations of the text-image pairs and the text representation of the text instruction to update the latent representation of the target image at each of multiple reverse diffusion steps. In particular, in the example 400, the system perform T reverse diffusion (“inference”) steps when generating the target image.

In particular, as shown in the example 400, the system processes a first diffusion input for the reverse diffusion step that includes (i) the latent representation of the target image and (ii) the text representation of the text instruction using the denoising encoder neural network to generate a first encoded representation of the target image. In the example 400, the system generates the first diffusion input by generating a new encoder input sequence that includes (i) embeddings from the latent representation of the target image and (ii) the text representation of the text instruction and processes the new encoder input sequence using the denoising encoder neural network to generate the first encoded representation of the target image.

The system 100 then processes the first encoded representation of the target image and the encoded representations of the text-image pairs using the denoising decoder neural network of the latent denoising neural network to generate a first denoising output in the latent space.

In the example 400, the system generates a decoder input sequence that includes (i) embeddings from the first encoded representation of the target image and (ii) for each text-image pair, embeddings from the encoded representation of the text-image pair and processes the decoder input sequence using the denoising decoder neural network to generate the first denoising output.

For example, as shown in the example 400, the system generates the decoder input sequence by concatenating (i) the embeddings from the first encoded representation of the target image and (ii) for each text-image pair, the embeddings from the encoded representation of the text-image pair along the sequence dimension.

The system 100 then uses the first denoising output to update the latent representation as described above with reference to FIGS. 1-3.

After updating the latent representation of the target data item using the latent denoising neural network at each of the reverse diffusion steps, the system 100 processes the latent representation using the latent decoder neural network, e.g., latent decoder neural network 190, to generate the target image.

In particular, FIG. 4 shows three example target images that can be generated by the system 100 by processing the multi-modal instruction. Because of the stochasticity involved in generating the image, e.g., as a result of the noise sampled for initializing the latent representation, the system 100 can generate multiple plausible target images for any given multi-modal instruction.

Prior to using the latent denoising neural network to generate images, the system 100 or another training system trains the latent denoising neural network.

As a particular example, the system can obtain a pre-trained text encoder neural network and pre-trained latent encoder and decoder neural networks, and then use these pre-trained neural networks to train the latent denoising neural network.

The training system can generally train the latent denoising neural network on any appropriate diffusion model training objective, e.g., a score matching objective, and so on. Generally, the objective will measure an error, e.g., a mean-squared error (MSE), or an L2 error, between (i) a ground truth denoising output generated based on noise that was applied to a latent representation of a ground truth target image generated by processing the ground truth target image using the latent encoder neural network and (ii) the denoising output generated by the latent denoising neural network by processing an input that includes the noisy latent representation.

In some cases, the training system directly trains the latent denoising neural network on the multi-modal instruction following task, i.e., where the input to the latent denoising neural network during training includes latent representations of reference image-text pairs as described above.

In some other cases, however, the latent denoising neural network has been pre-trained, e.g., by the same system that performs the training on the multi-modal instruction following task or by a different system, on one or more text-conditioned image generation tasks. That is, the latent denoising neural network has been pre-trained on one or more tasks that measure how well the latent denoising neural network can be used to generate an image conditioned on only a text input, i.e., rather than a multi-modal input. That is, in these pre-training tasks, the input to the latent denoising neural network during training includes a representation of a text input but no latent representations of reference image-text pairs.

In these cases, after the pre-training, the training system trains the latent denoising neural network on a task that requires generating images conditioned on training multi-modal inputs that each include (i) a respective training text instruction that describes an image generation task to be performed with reference to a respective set of one or more training reference images and (ii) the respective set of one or more training reference images.

Advantageously, the training of the latent denoising neural network on this multi-modal task does not require modifying the architecture of the latent denoising neural network or otherwise increasing the number of parameters of the latent denoising neural network.

In particular, because the reference image and reference text are encoded using the pre-trained latent and text encoder neural networks, respectively, no additional components are needed to generate the latent representations of this new data.

Moreover, because the encoded representations of the pairs are generated using the same denoising encoder neural network that was already being used to encode the latent representation of the target image, no additional components are needed to generate the encoded representations of the new data.

As a result, the multi-modal instruction following neural network has the same architecture and compute requirements as the neural network that was only trained to perform the simpler, text-conditional generation task.

FIGS. 2-4 describes examples where the target data item being generated is an image. More generally, however, as described above with reference to FIG. 1, the system can generate any appropriate type of data item conditioned on any appropriate multi-modal input.

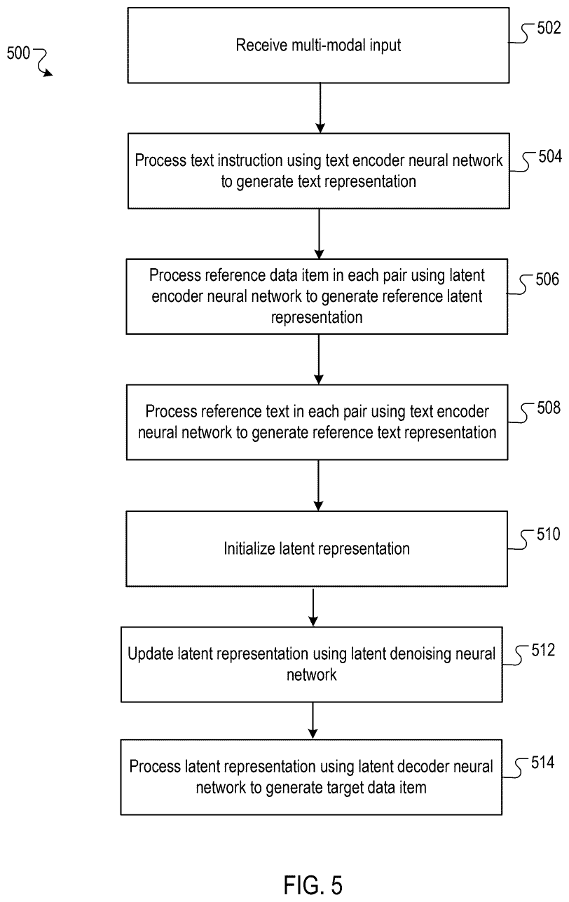

FIG. 5 is a flow diagram of an example process 500 for generating a target data item. For convenience, the process 500 will be described as being performed by a system of one or more computers located in one or more locations. For example, a multi-modal processing system, e.g., the multi-modal processing system 100 depicted in FIG. 1, appropriately programmed in accordance with this specification, can perform the process 500.

The system receives a multi-modal input (step 502).

The multi-modal input includes a text instruction that describes a data item generation task to be performed with reference to a set of one or more reference data items. Generally, the text instruction includes a respective text reference to each of the one or more reference data items. For example, each reference data item can contain a depiction of a respective object or entity and the text instruction can include one or more references to each of the respective object or entity depicted in the one or more reference data items.

The multi-modal input also includes a respective text-data item pair for each reference data item in the set, wherein each text-data item pair includes (i) the reference data item and (ii) a respective text reference for the reference data item. The text reference generally for a given reference data item generally describes the given reference data item.

The system processes the text instruction using a text encoder neural network to generate a text representation of the text instruction (step 504).

For each text-data item pair, the system processes the reference data item in the pair using a latent encoder neural network to generate a reference latent representation of the reference data item in the latent space (step 506) and processes the text reference in the pair using the text encoder neural network to generate a reference text representation of the text reference (step 508).

Thus, after performing steps 504-508, the system transforms the multi-modal input into (i) a text representation of the text instruction and (ii) a respective latent representation and reference text representation for each text-data item pair.

The system initializes a latent representation of a target data item for the data item generation task in the latent space (step 510).

The system updates the latent representation of the target data item using a latent denoising neural network conditioned on the text representation of the text instruction and the representations for the text-data item pairs (step 512).

This updating can be performed as described above with reference to FIGS. 3 and 4.

After updating the latent representation of the target data item using the latent denoising neural network, the system processes the latent representation using a latent decoder neural network to generate the target data item (step 514).

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models. Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a multi-modal input, wherein the multi-modal input comprises:
a text instruction that describes an image generation task to be performed with reference to a set of one or more reference images, wherein the text instruction includes a respective text reference to each of the one or more reference images, and
a respective text-image pair for each reference image in the set, wherein each text-image pair comprises (i) the reference image and (ii) the respective text reference for the reference image;
initializing a latent representation of a target image for the image generation task in a latent space;
processing the text instruction using a text encoder neural network to generate a text representation of the text instruction;
for each text-image pair:
processing the reference image in the pair using a latent encoder neural network to generate a reference latent representation of the reference image in the latent space, and
processing the text reference in the pair using the text encoder neural network to generate a reference text representation of the text reference; and
updating the latent representation of the target image using a latent denoising neural network, the updating comprising:
for each text-image pair, processing the reference latent representation of the reference image in the pair and the reference text representation of the text reference in the pair using a denoising encoder neural network of the latent denoising neural network to generate an encoded representation of the text-image pair; and
at each of a plurality of reverse diffusion steps:
generating a denoising output in the latent space for the reverse diffusion step, comprising:
processing a first diffusion input for the reverse diffusion step that comprises (i) the latent representation of the target image and (ii) the text representation of the text instruction using the denoising encoder neural network to generate a first encoded representation of the target image; and
processing the first encoded representation of the target image and the encoded representations of the text-image pairs using a denoising decoder neural network of the latent denoising neural network to generate a first denoising output in the latent space; and
updating the latent representation of the target image using the denoising output; and
after updating the latent representation of the target image using the latent denoising neural network, processing the latent representation using a latent decoder neural network to generate the target image.

2. The method of claim 1, wherein the set of one or more reference images comprises a plurality of reference images.

3. The method of claim 1, wherein processing the first encoded representation of the target image and the encoded representations of the text-image pairs using a denoising decoder neural network of the latent denoising neural network to generate a first denoising output comprises:
generating a decoder input sequence that includes (i) embeddings from the first encoded representation of the target image and (ii) for each text-image pair, embeddings from the encoded representation of the text-image pair; and
processing the decoder input sequence using the denoising decoder neural network to generate the first denoising output.

4. The method of claim 3, wherein the denoising decoder neural network comprises one or more self-attention layers that each update the embeddings in the decoder input sequence by applying self-attention over the embeddings in the decoder input sequence.

5. The method of claim 1, wherein, for each text-image pair, processing the reference latent representation of the reference image in the pair and the reference text representation of the text reference in the pair using a denoising encoder neural network of the latent denoising neural network to generate an encoded representation of the text-image pair comprises:
generating an encoder input sequence that includes (i) embeddings from the reference latent representation of the reference image in the pair and (ii) embeddings from the reference text representation of the text reference in the pair; and
processing the encoder input sequence using the denoising encoder neural network to generate the encoded representation of the text-image pair.

6. The method of claim 5, wherein the denoising encoder neural network comprises one or more self-attention layers that each update the embeddings in the encoder input sequence by applying self-attention over the embeddings in the encoder input sequence.

7. The method of claim 5, wherein processing a first diffusion input for the reverse diffusion step that comprises (i) the latent representation of the target image and (ii) the text representation of the text instruction using the denoising encoder neural network to generate a first encoded representation of the target image comprises:
generating a new encoder input sequence that includes (i) embeddings from the latent representation of the target image and (ii) the text representation of the text instruction; and
processing the new encoder input sequence using the denoising encoder neural network to generate the first encoded representation of the target image.

8. The method of claim 1, wherein the latent denoising neural network has been pre-trained on one or more text-conditioned image generation tasks.

9. The method of claim 8, wherein, after the pre-training, the latent denoising neural network has been trained on a task that requires generating images conditioned on training multi-modal inputs that each include (i) a respective training text instruction that describes an image generation task to be performed with reference to a respective set of one or more training reference images and (ii) the respective set of one or more training reference images.

10. The method of claim 9, wherein the latent encoder and latent decoder neural networks have been held fixed during the training of the latent denoising neural network on the task that requires generating images conditioned on the training multi-modal inputs.

11. The method of claim 10, wherein the latent encoder and latent decoder neural networks have been pre-trained on an image reconstruction task prior to the pre-training of the latent denoising neural network on the one or more text-conditioned image generation tasks.

12. The method of claim 10, wherein the text encoder neural network has been held fixed during the training of the latent denoising neural network on the task that requires generating images conditioned on the training multi-modal inputs.

13. The method of claim 1, wherein the denoising output in the latent space for the reverse diffusion step is the first denoising output.

14. The method of claim 1, wherein generating a denoising output in the latent space for the reverse diffusion step further comprises:
processing a second, unconditional diffusion input for the reverse diffusion step that comprises the latent representation of the target image using the denoising encoder neural network to generate a second encoded representation of the target image;
processing the second encoded representation of the target image using the denoising decoder neural network to generate a second denoising output in the latent space; and
combining the first and second denoising outputs in accordance with a guidance weight for the reverse diffusion step to generate the denoising output.

15. A method performed by one or more computers, the method comprising:
receiving a multi-modal input, wherein the multi-modal input comprises:
a text instruction that describes a data item generation task to be performed with reference to a set of one or more reference data items, wherein the text instruction includes a respective text reference to each of the one or more reference data items, and wherein each of the reference data items are of a respective different modality that is not text; and
a respective text-data item pair for each reference data item in the set, wherein each text-data item pair comprises (i) the reference data item and (ii) the respective text reference for the reference data item;
initializing a latent representation of a target data item for the data item generation task in a latent space;
processing the text instruction using a text encoder neural network to generate a text representation of the text instruction;
for each text-data item pair:
processing the reference data item in the pair using a latent encoder neural network to generate a reference latent representation of the reference data item in the latent space, and
processing the text reference in the pair using the text encoder neural network to generate a reference text representation of the text reference;
updating the latent representation of the target data item using a latent denoising neural network conditioned on, for each text-data item pair, the reference latent representation of the reference data item in the pair and the reference text representation of the text reference in the pair; and
after updating the latent representation of the target data item using the latent denoising neural network, processing the latent representation using a latent decoder neural network to generate the target data item.

16. The method of claim 15, wherein updating the latent representation of the target data item using a latent denoising neural network comprises:
for each text-data item pair, processing the reference latent representation of the reference data item in the pair and the reference text representation of the text reference in the pair using a denoising encoder neural network of the latent denoising neural network to generate an encoded representation of the text-data item pair; and
at each of a plurality of reverse diffusion steps:
generating a denoising output in the latent space for the reverse diffusion step, comprising:
processing a first diffusion input for the reverse diffusion step that comprises (i) the latent representation of the target data item and (ii) the text representation of the text instruction using the denoising encoder neural network to generate a first encoded representation of the target data item; and
processing the first encoded representation of the target data item and the encoded representations of the text-data item pairs using a denoising decoder neural network of the latent denoising neural network to generate a first denoising output in the latent space; and
updating the latent representation of the target data item using the denoising output.

17. The method of claim 16, wherein, for each text-image pair, processing the reference latent representation of the reference image in the pair and the reference text representation of the text reference in the pair using a denoising encoder neural network of the latent denoising neural network to generate an encoded representation of the text-image pair comprises:
generating an encoder input sequence that includes (i) embeddings from the reference latent representation of the reference image in the pair and (ii) embeddings from the reference text representation of the text reference in the pair; and
processing the encoder input sequence using the denoising encoder neural network to generate the encoded representation of the text-image pair.

18. The method of claim 15, wherein the reference data items are a same modality as the target data item.

19. The method of claim 15, wherein the reference data items are a different modality from the target data item.

20. A system comprising one or more computers and one or more storage devices storing instructions that are operable, when executed by the one or more computers, to cause the one or more computers to perform operations comprising:
receiving a multi-modal input, wherein the multi-modal input comprises:
a text instruction that describes an image generation task to be performed with reference to a set of one or more reference images, wherein the text instruction includes a respective text reference to each of the one or more reference images, and
a respective text-image pair for each reference image in the set, wherein each text-image pair comprises (i) the reference image and (ii) the respective text reference for the reference image;
initializing a latent representation of a target image for the image generation task in a latent space;
processing the text instruction using a text encoder neural network to generate a text representation of the text instruction;
for each text-image pair:
processing the reference image in the pair using a latent encoder neural network to generate a reference latent representation of the reference image in the latent space, and
processing the text reference in the pair using the text encoder neural network to generate a reference text representation of the text reference; and
updating the latent representation of the target image using a latent denoising neural network, the updating comprising:
for each text-image pair, processing the reference latent representation of the reference image in the pair and the reference text representation of the text reference in the pair using a denoising encoder neural network of the latent denoising neural network to generate an encoded representation of the text-image pair; and
at each of a plurality of reverse diffusion steps:
generating a denoising output in the latent space for the reverse diffusion step, comprising:
processing a first diffusion input for the reverse diffusion step that comprises (i) the latent representation of the target image and (ii) the text representation of the text instruction using the denoising encoder neural network to generate a first encoded representation of the target image; and
processing the first encoded representation of the target image and the encoded representations of the text-image pairs using a denoising decoder neural network of the latent denoising neural network to generate a first denoising output in the latent space; and
updating the latent representation of the target image using the denoising output; and
after updating the latent representation of the target image using the latent denoising neural network, processing the latent representation using a latent decoder neural network to generate the target image.
